(19) United States
(12) Patent Application Publication
(10) Pub. No.: US 2009/0317307 A1
(43) Pub. Date: Dec. 24, 2009

(54) EXHAUST GAS PURIFYING DEVICE

(76) Inventor: Takaaki Kanazawa, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/096,388

(22) PCT Filed: Nov. 20, 2006
(86) PCT No.: PCT/JP2006/323535

§ 371 Date: Jun. 6, 2008

(30) Foreign Application Priority Data
Dec. 12, 2005 (JP) 2005-357525

(51) Int. Cl. B01D 53/94

(52) U.S. Cl. 422/171

(57) ABSTRACT

An exhaust gas purifying device including an HC adsorbent (1) comprising zeolite loaded with at least one of Pd and Ag by ion exchange, and a NOₓ adsorbent (2) disposed in an exhaust gas passage downstream of the HC adsorbent (1) and comprising zeolite loaded with at least one of Fe, Cu and Co by ion exchange. The NOₓ adsorbent (2) has a superior NOₓ adsorbability in a low temperature range in an atmosphere having low HC concentrations. Therefore, by disposing the HC adsorbent (1) upstream of the NOₓ adsorbent (2), both HC and NOₓ can be sufficiently adsorbed and removed. Thus, harmful substances can be adsorbed and removed sufficiently even at ordinary temperatures around room temperature.

### TECHNICAL FIELD

The present invention relates to an exhaust gas purifying device for purifying harmful substances contained in automotive exhaust gas and specifically relates to an exhaust gas purifying device for adsorbing and removing harmful substances contained in a low-temperature exhaust gas immediately after an engine start. Although it is possible to use the exhaust gas purifying device of the present invention alone, it is desirable to use this device with at least one of a variety of exhaust gas purifying catalysts disposed upstream or downstream of this device.

### BACKGROUND ART

Owing to improvements in the technology of exhaust gas purifying catalysts such as three-way catalysts and NOₓ storage and reduction catalysts, harmful component emissions of exhaust gases from automobiles have become extremely small. However, since these exhaust gas purifying catalysts purify harmful components by the oxidative or reductive catalytic action of catalytic metals such as Pt contained in the catalysts, these catalysts have a problem of being inactive below the activating temperatures (about 200° C.) of the catalytic metals.

Namely, during the several tens of seconds from immediately after an engine start to the time when the exhaust gas purifying catalyst temperature rises to the activating temperature of catalytic metals, harmful components are emitted without being purified. Particularly in winter, the period in which harmful components are emitted without being purified becomes longer.

Therefore, it can be thought of to suppress emissions of harmful components by adsorption over the period from immediately after an engine start to the time when the exhaust gas purifying catalyst temperature rises to the activating temperature of catalytic metals.

For example, Japanese Examined Patent Publication (KOKOKU) No. 06-015016 proposes an exhaust gas purifying device provided with an adsorbent trapper comprising zeolite. Zeolite has a high HC adsorbability and its high HC adsorbability does not decrease even if used for a long time at elevated temperatures. Namely, zeolite is also superior in durability. Therefore, since this exhaust gas purifying device can adsorb HC in a low temperature range before a catalyst is activated, this device can suppress HC emissions.

Besides, Japanese Unexamined Patent Publication (KOKAI) No. 2001-198455 discloses a NOₓ adsorbent which comprises an oxide of at least one metal selected from the group consisting of Co, Fe and Ni and adsorbs large amounts of NOₓ in a low temperature range of 40° C. or less. This NOₓ adsorbent has a superior low-temperature NOₓ adsorbability as indicated by a saturated NOₓ adsorption of 10×10⁻⁵ mol/g or more in a gas at or below 40° C.

Moreover, Japanese Unexamined Patent Publication (KOKAI) No. 2001-289035 mentions a NOₓ adsorbent comprising alkali metal oxides, alkaline earth metal oxides, CO₃O₄, NiO₂, MnO₂, Fe₂O₃, ZrO₂, zeolite or the like, and states that the NOₓ adsorbent can adsorb NOₓ contained in exhaust gas in low to medium temperature ranges.

However, even the above adsorbents are still low in adsorbability at ordinary temperatures around room temperature, and have a problem that certain amounts of HC and NOₓ are emitted before exhaust gas purifying catalysts reach their activating temperatures.

The present invention has been made in view of the above circumstances. It is a primary object of the present invention to provide an exhaust gas purifying device which is capable of adsorbing and removing harmful substances sufficiently at ordinary temperatures around room temperature.

### DISCLOSURE OF THE INVENTION

The exhaust gas purifying device, which dissolves the above problem, is characterized in that it includes an HC adsorbent comprising zeolite loaded with at least one of Pd and Ag by ion exchange, and a NOₓ adsorbent disposed in an exhaust gas passage downstream of the HC adsorbent and comprising zeolite loaded with at least one selected from the group consisting of Fe, Cu and Co by ion exchange, thereby adsorbing and removing harmful substances contained in a low-temperature exhaust gas immediately after an engine start.

It is preferable that a CO adsorbent comprising Pd-loaded ceria is further disposed in the exhaust gas passage downstream of the NOₓ adsorbent. In addition, it is desirable that at least one of a three-way catalyst and a NOₓ storage and reduction catalyst is further disposed in the exhaust gas passage upstream or downstream of the abovementioned exhaust gas purifying device.

### BRIEF DESCRIPTION OF THE DRAWINGS

FIG. 1 is an explanatory diagram schematically illustrating an exhaust gas purifying device according to Example 1 of the present invention.

FIG. 2 is an explanatory diagram schematically illustrating an exhaust gas purifying device according to Example 5 of the present invention.

FIG. 3 is an explanatory diagram schematically illustrating an exhaust gas purifying device according to Comparative Example 7.

FIG. 4 is an explanatory diagram schematically illustrating an exhaust gas purifying device according to Example 6 of the present invention.

### BEST MODES FOR CARRYING OUT THE INVENTION

In the use of the exhaust gas purifying device of the present invention, exhaust gas contacts the HC adsorbent first. Since this HC adsorbent has a remarkably higher HC adsorbability in a low temperature range than zeolite, this HC adsorbent adsorbs and removes most of the HC contained in a low-temperature exhaust gas at an engine start. The exhaust gas which has much lower HC concentrations contacts the NOₓ adsorbent next. Since this NOₓ adsorbent has a remarkably high NOₓ adsorbability in a low temperature range in an atmosphere having low HC concentrations, this NOₓ adsorbent adsorbs and removes most of the NOₓ contained in the low-temperature exhaust gas at the engine start.

Hence, the exhaust gas which has passed through the HC adsorbent and the NOₓ adsorbent contains little HC and NOₓ, and harmful substance emissions at the engine start can be reduced significantly.

Further, if a CO adsorbent comprising Pd-loaded ceria is disposed downstream of the NOₓ adsorbent, since this CO adsorbent has a remarkably high CO adsorbability in a low temperature range in an atmosphere having low HC and NOₓ concentrations, the CO adsorbent adsorbs and removes most of the CO contained in the low-temperature exhaust gas at the engine start. Hence, the exhaust gas which has passed through the HC adsorbent, the NOₓ adsorbent and the CO adsorbent contain little HC, NOₓ and CO, harmful substance emissions at the engine start can be reduced significantly.

Zeolites, also known as molecular sieves, have micropores of molecular size and are used not only as adsorbents but also as catalysts for a lot of reactions. Since zeolites contain cations in order to neutralize the negative charge of Al₂O₃, which is a main component of zeolites, and these cations are easily exchanged with other cations in aqueous solutions, zeolites are also used as cation exchangers. Therefore, zeolites can be loaded with a variety of metallic elements by ion exchange and, besides, can be loaded with these metallic elements in a very highly dispersed state.

Examples of zeolites used as the HC adsorbent or the NOₓ adsorbent include ferrierite, ZSM-5, mordenite, Y-type zeolite, zeolite beta, synthetic zeolite produced by adding a template material to silica sol to form a gel, carrying out hydrothermal synthesis and then calcining the resultant material, and the like. Moreover, it is desirable to use either ZSM-5 or mordenite because ZSM-5 and mordenite have superior ion exchangeability.

The HC adsorbent used in the present invention comprises zeolite loaded with at least one of Pd and Ag by ion exchange. Zeolite alone has a high HC adsorbability, but zeolite loaded with Pd or Ag by ion exchange exhibits a high HC adsorbability even at ordinary temperatures around room temperature, although the reason is not known.

It is desirable that at least one of Pd and Ag is loaded on 10% or more of the ion exchange sites of zeolite. When the amount loaded is less than 10% of the ion exchange sites, a sufficient HC adsorbability is not exhibited and it is not suitable for practical use.

The shape of the HC adsorbent can be powders or pellets, but it is desirable that the HC adsorbent has a honeycomb shape in view of the balance between pressure loss and adsorbability. Namely, it is desirable to form a coating layer comprising HC adsorbent powder on cell surfaces of a honeycomb-shaped structure.

The NOₓ adsorbent used in the present invention comprises zeolite loaded with at least one selected from the group consisting of Fe, Cu and Co by ion exchange. Zeolite alone adsorbs certain amounts of NOₓ, but zeolite loaded with at least one selected from the group consisting of Fe, Cu and Co by ion exchange exhibits a high NOₓ adsorbability even at ordinary temperatures around room temperature, although the reason is not known. This NOₓ adsorbent has a problem that the presence of HC in an atmosphere slightly reduces the NOₓ adsorbability due to HC poisoning. In the present invention, however, most of the HC are adsorbed by the HC adsorbent disposed upstream of the NOₓ adsorbent and the exhaust gas flowing into the NOₓ adsorbent has extremely low HC concentrations. Therefore, the NOₓ adsorbent exhibits a high NOₓ adsorbability and adsorbs most of the NOₓ contained in the exhaust gas even at ordinary temperatures around room temperature.

It is desirable that at least one selected from the group consisting of Fe, Cu and Co is loaded on 10% or more of the ion exchange sites of zeolite. When the amount loaded is less than 10% of the ion exchange sites, a sufficient NOₓ adsorbability is not exhibited and it is not suitable for practical use.

The shape of the NOₓ adsorbent can be powders or pellets, but it is desirable that the NOₓ adsorbent has a honeycomb shape in view of the balance between pressure loss and adsorbability. Namely, it is desirable to form a coating layer comprising NOₓ adsorbent powder on cell surfaces of a honeycomb-shaped structure.

In the period from an engine start to the time when a catalyst reaches its activating temperature, most of the HC and NOₓ in the exhaust gas can be adsorbed and removed by the HC adsorbent and the NOₓ adsorbent, and a harmful component to be emitted is CO alone. Therefore, it is desirable to also remove CO. In this case, it is desirable that a CO adsorbent is further disposed in the exhaust gas passage downstream of the NOₓ adsorbent in order to adsorb CO over the period from the engine start to the time when the catalyst reaches its activating temperature.

It is particularly desirable that the CO adsorbent is Pd-loaded ceria. Probably because Pd, which is loaded on ceria, is peroxidized with oxygen supplied from ceria, the Pd-loaded ceria exhibits a high CO adsorbability even at ordinary temperatures around room temperature. Besides, since the adsorbent comprising Pd-loaded ceria also adsorbs NOₓ and also suffers from HC poisoning, this adsorbent has a problem that its CO adsorbability decreases in an atmosphere containing HC or NOₓ. In the present invention, however, most of the HC and NOₓ are adsorbed by the HC adsorbent and NOₓ adsorbent disposed upstream of the CO adsorbent and the exhaust gas flowing into the CO adsorbent has extremely low HC and NOₓ concentrations. Therefore, the CO adsorbent exhibits a high CO adsorbability and adsorbs most of the CO contained in the exhaust gas even at ordinary temperatures around room temperature.

It is desirable that the amount of Pd loaded in the CO adsorbent is in the range of from 1 to 20% by weight. When the amount loaded is less than 1% by weight, a sufficient CO adsorbability is not exhibited and it is not suitable for practical use. On the other hand, when Pd is loaded in an amount of more than 20% by weight, the CO adsorbability is saturated and it results in a cost increase.

The shape of the CO adsorbent can be powders or pellets, but it is desirable that the CO adsorbent has a honeycomb shape in view of the balance between pressure loss and adsorbability. Namely, it is desirable to form a coating layer comprising CO adsorbent powder on cell surfaces of a honeycomb-shaped structure.

When the exhaust gas temperature rises high, the exhaust gas purifying device of the present invention releases the adsorbed harmful substances. Therefore, in order to prevent these emissions, it is desirable that at least one of a three-way catalyst and a NOₓ storage and reduction catalyst is further disposed in the exhaust gas passage upstream or downstream of the device of the present invention, so that the catalyst purifies the released harmful substances.

For example, when a CO adsorbent is not employed, a catalyst is disposed downstream of the NOₓ adsorbent. In a low temperature range before the catalyst reaches its activating temperature, HC and NOₓ are respectively adsorbed by the HC adsorbent and the NOₓ adsorbent. After the catalyst reaches its activating temperature, the HC released from the HC adsorbent and the NOₓ released from the NOₓ adsorbent are purified on the catalyst. Hence, HC and NOₓ emissions can be suppressed over the entire temperature range.

On the other hand, when a CO adsorbent is employed, a catalyst is disposed downstream of the CO adsorbent. In a low temperature range before the catalyst reaches its activating temperature, HC, NOₓ and CO are respectively adsorbed by the HC adsorbent, the NOₓ adsorbent and the CO adsorbent. After the catalyst reaches its activating temperature, the HC released from the HC adsorbent, the NOₓ released from the NOₓ adsorbent and the CO released from the CO adsorbent are purified on the catalyst. Hence HC, NOₓ and CO emissions can be suppressed over the entire temperature range.

It should be noted that a catalyst can be disposed upstream of the HC adsorbent. In this case, a bypass circuit may be provided and when the exhaust gas temperature exceeds a predetermined temperature, the exhaust gas emitted from the NOₓ adsorbent or the CO adsorbent may be supplied upstream of the catalyst. However, if the exhaust gas is always passed through the respective adsorbents, it can cause a problem of increasing pressure loss. Therefore, when the bypass circuit is provided, it is desirable that the exhaust gas is passed through the respective adsorbents only during the period from an engine start to the time when the catalyst reaches its activating temperature, and that the exhaust gas is passed through the catalyst alone after the catalyst reaches its activating temperature.

The volume of the HC adsorbent, the NOₓ adsorbent and CO adsorbent used varies with the absolute amounts and concentrations of the respective components to be adsorbed, and also varies with an engine displacement and engine operating conditions. In general, however, only half of the volume of a three-way catalyst or the like is sufficient for that of each adsorbent, and the space for mounting these adsorbents can be small.

### EXAMPLES

Hereinafter, the present invention will be described specifically by way of examples and comparative examples.

### (Preparation of Respective Adsorbents)

200 g of ZSM-5 powder, 70 g of silica sol, and pure water were mixed to prepare a slurry. This slurry was uniformly coated on cordierite honeycomb structures (capacity: 35 cc, cell density: 400 cells/inch²), dried at 250° C. for one hour, and then calcined at 500° C. for one hour, thereby forming a zeolite coating layer on each of the structures. The zeolite coating layer was formed in an amount of 200 g per liter of the honeycomb structure.

One of the honeycomb structures having the zeolite coating layer was immersed in an aqueous silver nitrate solution of a predetermined concentration for one hour, and then calcined at 500° C. for one hour, thereby loading Ag on the zeolite coating layer by ion exchange. An HC adsorbent (loaded with Ag) was thus prepared. The amount of ion exchanged Ag relative to Al atom in mordenite was Al:Ag=1:1.

Another of the honeycomb structures having the zeolite coating layer was immersed in an aqueous palladium nitrate solution of a predetermined concentration for one hour, and then calcined at 500° C. for one hour, thereby loading Pd on the zeolite coating layer by ion exchange. An HC adsorbent (loaded with Pd) was thus prepared. The amount of ion exchanged Pd relative to Al atom in mordenite was Al:Pd=2:1.

Still another of the above-mentioned honeycomb structures having the zeolite coating layer was immersed in an aqueous ferric nitrate solution of a predetermined concentration for one hour, and then calcined at 500° C. for one hour, thereby loading Fe on the zeolite coating layer by ion exchange. A NOₓ adsorbent (loaded with Fe) was thus prepared. The amount of ion exchanged Fe relative to Al atom in mordenite was Al:Fe=3:1.

Another of the above-mentioned honeycomb structures having the zeolite coating layer was immersed in an aqueous cobalt nitrate solution of a predetermined concentration for one hour, and then calcined at 500° C. for one hour, thereby loading Co on the zeolite coating layer by ion exchange. A NOₓ adsorbent (loaded with Co) was thus prepared. The amount of ion exchanged Co relative to Al atom in mordenite was Al:Co=2:1.

Another of the above-mentioned honeycomb structures having the zeolite coating layer was immersed in an aqueous copper nitrate solution of a predetermined concentration for one hour, and then calcined at 500° C. for one hour, thereby loading Cu on the zeolite coating layer by ion exchange. A NOₓ adsorbent (loaded with Cu) was thus prepared. The amount of ion exchanged Cu relative to Al atom in mordenite was Al:Cu=2:1.

On the other hand, 200 g of CeO₂ powder and 250 g of ceria sol containing 15% solid CeO₂ were mixed to prepare a slurry. This slurry was uniformly coated on a similar honeycomb structure to the above, dried at 250° C. for one hour and then calcined at 500° C. for one hour, thereby forming a ceria coating layer. The ceria coating layer was formed in an amount of 200 g per liter of the honeycomb structure. The honeycomb structure having the ceria coating layer was impregnated with a predetermined amount of an aqueous palladium nitrate solution of a predetermined concentration, dried, and then dried at 500° C. for one hour, thereby loading Pd and preparing a CO adsorbent. The amount of Pd loaded was 5 g per liter of the honeycomb structure.

### Example 1

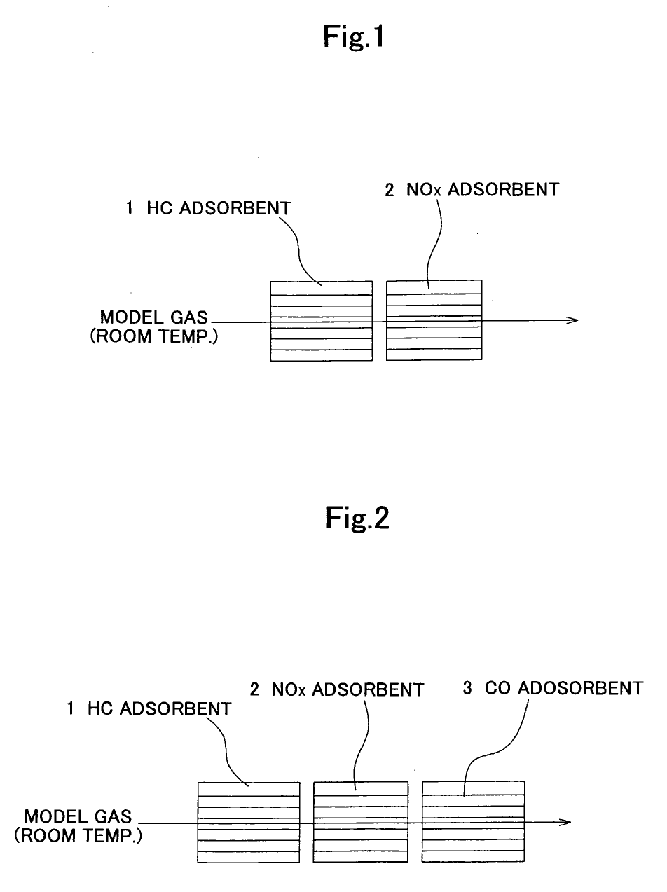

As shown in FIG. 1, the HC adsorbent (loaded with Ag) 1, and the NOₓ adsorbent (loaded with Fe) 2 prepared as above were disposed in a gas passage of evaluation equipment in this order from the upstream, thereby preparing an exhaust gas purifying device of Example 1. Then, a model gas comprising 3000 ppmC of C₃H₆ as HC, 900 ppm of NO₂, 6000 ppm of CO, 3% of H₂O, and the balance of N₂ was passed through the exhaust gas purifying device at room temperature (25° C.) at a flow rate of 10 liters/minute for 20 seconds. The amounts of respective components adsorbed by the exhaust gas purifying device were calculated from the concentrations of the respective components of the inlet gas and the outlet gas, and adsorption ratios were determined by calculating the ratios of the amounts of the respective adsorbed components to those of the respective components of the inlet gas. The results are shown in Table 1.

### Comparative Example 1

The NOₓ adsorbent (loaded with Fe) and the HC adsorbent (loaded with Ag) were disposed in the gas passage of the evaluation equipment in this order from the upstream, thereby preparing an exhaust gas purifying device of Comparative Example 1. The adsorption ratios of the respective components were measured in the same way as in Example 1, and the results are shown in Table 1.

### Example 2

The HC adsorbent (loaded with Pd) and the NOₓ adsorbent (loaded with Fe) were disposed in the gas passage of the evaluation equipment in this order from the upstream, thereby preparing an exhaust gas purifying device of Example 2. The adsorption ratios of the respective components were measured in the same way as in Example 1, and the results are shown in Table 1.

### Comparative Example 2

The NOₓ adsorbent (loaded with Fe) and the HC adsorbent (loaded with Pd) were disposed in the gas passage of the evaluation equipment in this order from the upstream, thereby preparing an exhaust gas purifying device of Comparative Example 2. The adsorption ratios of the respective components were measured in the same way as in Example 1, and the results are shown in Table 1.

### Example 3

The HC adsorbent (loaded with Ag) and the NOₓ adsorbent (loaded with Co) were disposed in the gas passage of the evaluation equipment in this order from the upstream, thereby preparing an exhaust gas purifying device of Example 3. The adsorption ratios of the respective components were measured in the same way as in Example 1, and the results are shown in Table 1.

### Comparative Example 3

The NOₓ adsorbent (loaded with Co) and the HC adsorbent (loaded with Ag) were disposed in the gas passage of the evaluation equipment in this order from the upstream, thereby preparing an exhaust gas purifying device of Comparative Example 3. The adsorption ratios of the respective components were measured in the same way as in Example 1, and the results are shown in Table 1.

### Example 4

The HC adsorbent (loaded with Ag) and the NOₓ adsorbent (loaded with Cu) were disposed in the gas passage of the evaluation equipment in this order from the upstream, thereby preparing an exhaust gas purifying device of Example 4. The adsorption ratios of the respective components were measured in the same way as in Example 1, and the results are shown in Table 1.

### Comparative Example 4

The NOₓ adsorbent (loaded with Cu) and the HC adsorbent (loaded with Ag) were disposed in the gas passage of the evaluation equipment in this order from the upstream, thereby preparing an exhaust gas purifying device of Comparative Example 4. The adsorption ratios of the respective components were measured in the same way as in Example 1, and the results are shown in Table 1.

### Comparative Example 5

The CO adsorbent and the HC adsorbent (loaded with Ag) were disposed in the gas passage of the evaluation equipment in this order from the upstream, thereby preparing an exhaust gas purifying device of Comparative Example 5. The adsorption ratios of the respective components were measured in the same way as in Example 1, and the results are shown in Table 1.

### Comparative Example 6

The HC adsorbent (loaded with Ag) and the CO adsorbent were disposed in the gas passage of the evaluation equipment in this order from the upstream, thereby preparing an exhaust gas purifying device of Comparative Example 6. The adsorption ratios of the respective components were measured in the same way as in Example 1, and the results are shown in Table 1.

### Example 5

As shown in FIG. 2, the HC adsorbent (loaded with Ag) 1, the NOₓ adsorbent (loaded with Fe) 2 and the CO adsorbent 3 were disposed in the gas passage of the evaluation equipment in this order from the upstream, thereby preparing an exhaust gas purifying device of Example 5. The adsorption ratios of the respective components were measured in the same way as in Example 1, and the results are shown in Table 1.

### Comparative Example 7

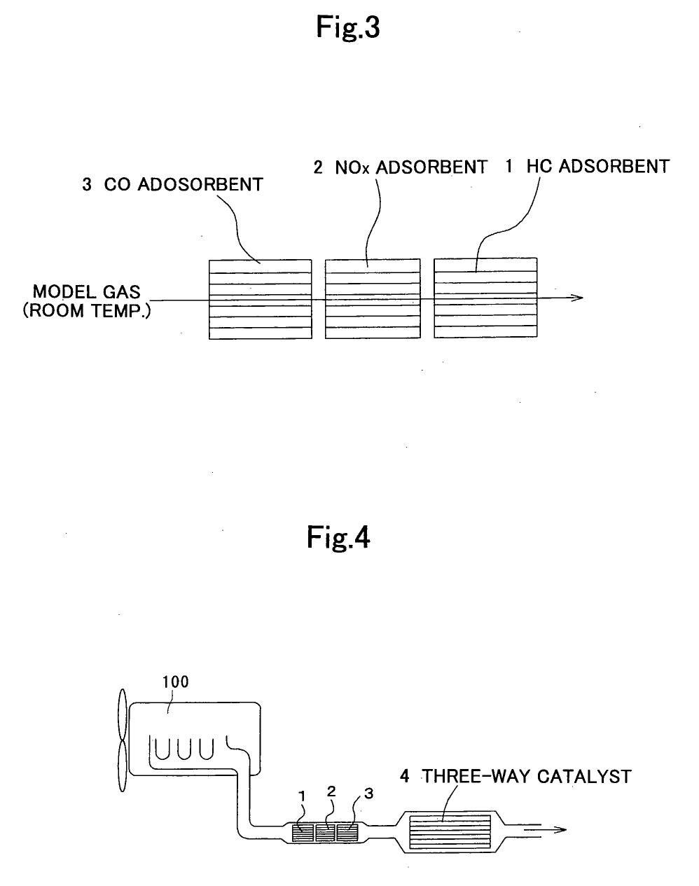

As shown in FIG. 3, the CO adsorbent 3, the NOₓ adsorbent (loaded with Fe) 2 and the HC adsorbent (loaded with Ag) 1 were disposed in the gas passage of the evaluation equipment in this order from the upstream, thereby preparing an exhaust gas purifying device of Comparative Example 7. The adsorption ratios of the respective components were measured in the same way as in Example 1, and the results are shown in Table 1.

### (Evaluation)

TABLE 1

| | | | | ADSOPRTION RATIO (%) | | |
|---|---|---|---|---|---|---|
| | UPSTREAM | MIDDLESTREAM | DOWNSTREAM | HC | NOx | CO |
| EX. 1 | HC adsorbent (loaded with Ag) | NOx adsorbent (loaded with Fe) | — | 100 | 100 | 12 |
| COMP. EX. 1 | NOx adsorbent (loaded with Fe) | HC adsorbent (loaded with Ag) | — | 100 | 93 | 9 |
| EX. 2 | HC adsorbent (loaded with Pd) | NOx adsorbent (loaded with Fe) | — | 100 | 100 | 14 |
| COMP. EX. 2 | NOx adsorbent (loaded with Fe) | HC adsorbent (loaded with Pd) | — | 100 | 98 | 7 |
| EX. 3 | HC adsorbent (loaded with Ag) | NOx adsorbent (loaded with Co) | — | 100 | 100 | 11 |
| COMP. EX. 3 | NOx adsorbent (loaded with Co) | HC adsorbent (loaded with Ag) | — | 100 | 97 | 5 |
| EX. 4 | HC adsorbent (loaded with Ag) | NOx adsorbent (loaded with Cu) | — | 100 | 100 | 8 |
| COMP. EX. 4 | NOx adsorbent (loaded with Cu) | HC adsorbent (loaded with Ag) | — | 100 | 94 | 10 |
| COMP. EX. 5 | CO adsorbent | HC adsorbent (loaded with Ag) | — | 100 | 52 | 62 |
| COMP. EX. 6 | HC adsorbent (loaded with Ag) | CO adsorbent | — | 100 | 100 | 96 |
| EX. 5 | HC adsorbent (loaded with Ag) | NOx adsorbent (loaded with Fe) | CO adsorbent | 100 | 100 | 100 |
| COMP. EX. 7 | CO adsorbent | NOx adsorbent (loaded with Fe) | HC adsorbent (loaded with Ag) | 100 | 100 | 71 |

A comparison of Example 1 and Example 2 indicates that there is little difference between Ag and Pd in the HC adsorbents, and both the HC adsorbents exhibited high HC adsorption ratios. A comparison of Examples 1, 3 and 4 indicates that there is little difference among Fe, Co and Cu in the NOₓ adsorbents and all of the NOₓ adsorbents exhibited high NOₓ adsorption ratios.

Comparative Examples 1 to 4 in which the NOₓ adsorbents were disposed upstream of the HC adsorbents exhibited lower NOₓ adsorption ratios than Examples 1 to 4 in which the adsorbents were disposed in the opposite order. It is clear from this that the presence of HC in the inlet exhaust gas reduces the NOₓ adsorbability of the NOₓ adsorbents and that the HC adsorbents need to be disposed upstream of the NOₓ adsorbents.

A comparison of Comparative Examples 5 and 6 indicates that CO adsorbability was remarkably lowered when the CO adsorbent was disposed upstream of the HC adsorbent. Namely, it is apparent that since the presence of HC in the inlet exhaust gas reduces the CO adsorbability of the CO adsorbents, the HC adsorbents need to be disposed upstream of the CO adsorbents. However, from the fact that Example 5 exhibited a higher CO adsorption ratio than Comparative Example 6, it is assumed that the presence of NOₓ in the inlet exhaust gas reduces the CO adsorbability of the CO adsorbents and it is desirable that the NOₓ adsorbents is also disposed upstream of the CO adsorbents.

The exhaust gas purifying device of Example 5 adsorbed all the three components, HC, NOₓ and CO at high adsorption ratios. Apparently this was an effect of the fact that the HC adsorbent, the NOₓ adsorbent and the CO adsorbent were disposed in this order from the upstream toward the downstream.

### Example 6

An exhaust gas purifying device of this example is shown in FIG. 4. In this exhaust gas purifying device, the HC adsorbent (loaded with Ag) 1, the NOₓ adsorbent (loaded with Fe) 2, and the CO adsorbent 3 were disposed in this order from the upstream in an exhaust system of an engine 100 which was controlled to maintain stoichiometric combustion, and a three-way catalyst 4 was disposed downstream of these adsorbents.

In the use of this exhaust gas purifying device, during the about 20 seconds after an start of the engine 100 to the time when the three-way catalyst 4 reaches its activating temperature, the HC, NOₓ and CO in the exhaust gas are respectively adsorbed by the HC adsorbent (loaded with Ag) 1, the NOₓ adsorbent (loaded with Fe) 2, and the CO adsorbent 3 and emissions of those substances can be reduced to almost zero. Then, when the three-way catalyst 4 reaches its activating temperature, the three-way catalyst 4 oxidizes HC and CO and reduces NOₓ into harmless substances. When the exhaust gas temperature rises further, the adsorbed HC, NOₓ and CO are released from the HC adsorbent (loaded with Ag) 1, the NOₓ adsorbent (loaded with Fe) 2 and the CO adsorbent 3, but the released HC, NOₓ and CO flow into the three-way catalyst 4 and are purified there.

Because the HC adsorbent (loaded with Ag) 1, the NOₓ adsorbent (loaded with Fe) 2, and the CO adsorbent 3 release the HC, NOₓ, and CO at elevated temperatures, these adsorbents recover their HC, NOₓ or CO adsorbability and keep these conditions even when the engine stops. Therefore, these adsorbents can adsorb HC, NOₓ and CO at the next engine start.

### INDUSTRIAL APPLICABILITY

The exhaust gas purifying device of the present invention can be used for purifying exhaust gas from internal combustion engines of automobiles or the like. This device can be used alone or in combination with at least one of various exhaust gas purifying catalysts.

1. An exhaust gas purifying device, including:
an HC adsorbent comprising zeolite loaded with at least one of Pd and Ag by ion exchange; and
a NOₓ adsorbent disposed in an exhaust gas passage downstream of the HC adsorbent and comprising zeolite loaded with at least one selected from the group consisting of Fe, Cu and Co by ion exchange,
thereby adsorbing and removing harmful substances contained in a low-temperature exhaust gas immediately after an engine start.

2. An exhaust gas purifying device as set forth in claim 1, wherein a CO adsorbent comprising Pd-loaded ceria is further disposed in the exhaust gas passage downstream of said NOₓ adsorbent.

3. An exhaust gas purifying device as set forth in claim 1, wherein at least one of a three-way catalyst and a NOₓ storage and reduction catalyst is further disposed in the exhaust gas passage upstream of said HC adsorbent or downstream of said NOₓ adsorbent.

4. An exhaust gas purifying device as set forth in claim 2, wherein at least one of a three-way catalyst and a NOₓ storage and reduction catalyst is further disposed in the exhaust gas passage upstream of said HC adsorbent or downstream of said CO adsorbent.
